(19) United States
(12) Patent Application Publication
(10) Pub. No.: US 2012/0137682 A1
(43) Pub. Date: Jun. 7, 2012

(54) TURBOCHARGING ARRANGEMENT AND METHOD FOR OPERATING AN INTERNAL COMBUSTION ENGINE

(75) Inventors: John HATLEY, Houston, TX (US); Leif KNIPSTR¿M, Winterthur (CH)

(73) Assignee: Wartsila Finland Oy, Vaasa (FI)

(21) Appl. No.: 12/961,320

(22) Filed: Dec. 6, 2010

(51) Int. Cl. F02C 6/12

(52) U.S. Cl. 60/608

(57) ABSTRACT

A turbocharging arrangement for an internal combustion engine, the arrangement having a turbocharger with a turbine and a compressor connected to a common shaft in a rotationally fixed manner, an electric motor, and coupling means for coupling the electric motor to the shaft of the turbocharger. The coupling means is arranged to steplessly adjust the torque transmitted between the electric motor and the turbocharger. A method for operating a turbocharged internal combustion engine is also provided.

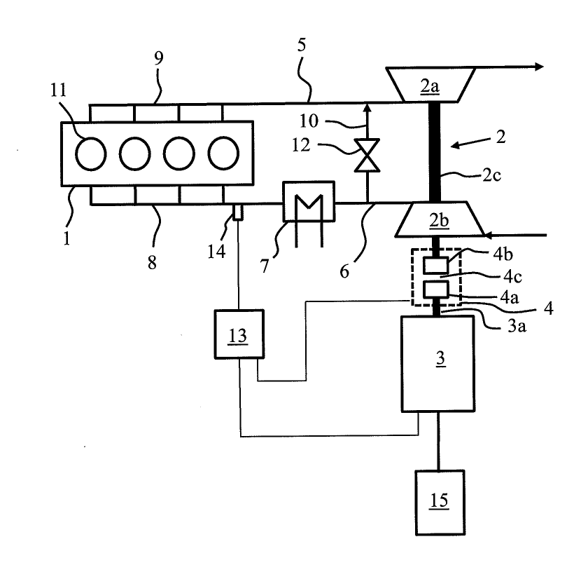

### TECHNICAL FIELD OF THE INVENTION

The present invention relates to a turbocharging arrangement for an internal combustion engine, as defined in the preamble of claim 1. The invention also concerns a method for operating a turbocharged internal combustion engine in accordance with the preamble of claim 5.

### BACKGROUND OF THE INVENTION

Modern internal combustion engines are often equipped with turbochargers to increase the power output, as well as the efficiency of the engine. A disadvantage of turbochargers driven by the exhaust gases is that turbochargers work efficiently only within a limited load range. Typically, turbochargers are efficient only at intermediate and high engine loads. Due to this inefficiency, the available engine torque is low at low loads, which leads to slow increase of the engine speed and load when requested.

The response of a turbocharger to a load increase is also delayed since the engine needs to produce more exhaust gases before the turbocharger speed starts to increase. This results in a reduced air to fuel ratio (lambda) during accelerations and load increases, which may lead to higher smoke emissions. The slow response of the turbocharger is a problem particularly in applications where an accurate lambda control and quick load response is required.

Different ways of boosting a turbocharger at low loads are known. For instance, compressed air can be introduced to the compressor wheel to speed up the turbocharger at low loads. Another option is to use an electric motor, which is either an integral part of the turbocharger or arranged externally. A disadvantage of compressed air is that it increases the load on the wings on the compressor wheel, and can thus only be used for short periods of time when a quick power increase is needed. The solutions with electric motors tend to be complicated since a frequency controller is needed for having the possibility to give an electric boost at any load. Also, the rotating inertia of the turbocharger is increased, making the turbocharger dependent on electric power supply to have a reasonable low load performance.

Still another option for assisting a turbocharger at low loads is to use a slip coupling between an electric motor and the turbocharger. Patent U.S. Pat. No. 6,305,169 B1 discloses a motor assisted turbocharger, where an eddy current coupling is used for connecting an electric motor to the turbocharger. The turbocharger comprises an inertia responsive mechanism for connecting and disconnecting the electric motor with the turbocharger. The turbine and the compressor of the turbocharger are arranged on separate shafts and connected via an overrunning clutch. The electric motor is automatically coupled with the compressor shaft when the motor is switched on, and when the speed of the turbine exceeds the speed of the motor, the electric motor is automatically decoupled from the compressor shaft.

A disadvantage of the turbocharger of U.S. Pat. No. 6,305,169 B1 is that the torque transmitted by the eddy current coupling cannot be adjusted but depends on the slip between the drive member and the driven member of the coupling. Another disadvantage of the turbocharger is that the electric motor cannot be used for braking the turbocharger.

### SUMMARY OF THE INVENTION

The object of the present invention is to provide an improved turbocharging arrangement for an internal combustion engine and an improved method for operating an internal combustion engine. The characterizing features of the arrangement and the method according to the present invention are given in the characterizing parts of claims 1 and 5, respectively.

According to the present invention, the turbocharging arrangement for an internal combustion engine comprises a turbocharger comprising a turbine and a compressor being connected to a common shaft in a rotationally fixed manner, an electric motor, and coupling means for coupling the electric motor to the shaft of the turbocharger. The coupling means is arranged to steplessly adjust the torque transmitted between the electric motor and the turbocharger.

The use of an electric motor for assisting the turbocharger enables a fast response of the turbocharger to increased load or engine speed. The engine speed and power output can be increased rapidly and air to fuel ratio can be kept at the optimum level avoiding high smoke emissions during acceleration. Because of infinite adjusting of the torque, optimal charge pressure can be achieved at any operating point of the engine. The engine can be operated at constant speed without a need for a frequency controller. The electric motor can also be used as a generator for reducing the speed of the turbocharger. Energy of the exhaust gases can be utilized optimally and turbocharger waste gates may be redundant.

According to an embodiment of the invention, the coupling means is an adjustable magnetic coupler. A magnetic coupler is advantageous as the coupling means since there is no mechanical connection between the driving and the driven members of the magnetic coupler. This makes the magnetic couplers reliable and almost maintenance-free.

According to an embodiment of the invention, the adjustable magnetic coupler comprises a first rotor with a plurality of permanent magnets, the first rotor being separated by an adjustable air gap from a second rotor comprising non-ferrous conductor elements. This type of magnetic coupler needs no external energy except for the driving motor.

According to an embodiment of the invention, the electric motor is a constant speed motor. Because of the adjustable coupling means between the motor and the turbocharger, the electric motor can be operated at constant speed.

According to the present invention, the method for operating a turbocharged internal combustion engine comprises a turbocharger comprising a turbine and a compressor being connected to a common shaft in a rotationally fixed manner, an electric motor, and adjustable coupling means for coupling the electric motor to the shaft of the turbocharger. The torque transmitted by the coupling means between the electric motor and the turbocharger is adjusted according to the needed charge air pressure.

By adjusting the torque transmitted by the coupling means between the electric motor and the turbocharger, optimal charge air pressure and quick response to load increase together with minimized smoke emissions can be achieved. Because the torque is adjusted by the adjustable coupling means, there is no need for changing the speed of the electric motor.

According to an embodiment of the invention, the torque transmitted is adjusted by an adjustable magnetic coupler.

According to an embodiment of the invention, the torque transmitted by the coupling means is adjusted according to the difference between the actual and desired charge air pressure.

By measuring the actual charge pressure and comparing it to the desired pressure level, accurate control of the turbocharger can be achieved.

According to an embodiment of the invention, the method comprises a first mode, in which mode the turbocharger is operated on both the exhaust gases of the internal combustion engine and the electric motor, a second mode, in which mode the turbocharger is operated on the exhaust gases of the internal combustion engine and the electric motor is disconnected from the turbocharger, and a third mode in which mode the electric motor is used as a generator.

The three different operating modes enable effective use of the turbocharger. When the electric motor is used for assisting the turbocharger, quick load response of the engine can be achieved. By disconnecting the electric motor from the turbocharger, the rotating inertia of the turbocharger can be minimized. By using the electric motor as a generator, the speed of the turbocharger can be reduced by converting the energy of the exhaust gases into electricity.

According to an embodiment of the invention, the electric motor is operated at constant speed.

### BRIEF DESCRIPTION OF THE DRAWINGS

The FIGURE shows schematically a turbocharging arrangement according to an embodiment of the invention.

### DETAILED DESCRIPTION OF THE INVENTION

The invention is now described in more detail with reference to the accompanying drawing. The FIGURE shows a turbocharging arrangement for an internal combustion engine 1 according to an embodiment of the present invention. The arrangement comprises a turbocharger 2 comprising a turbine 2a and a compressor 2b. The turbine 2a and the compressor 2b are connected to each other in a rotationally fixed manner via a shaft 2c.

The turbine 2a of the turbocharger 2 is connected with an exhaust manifold 9 and exhaust pipe 5 to the cylinders 11 of the engine 1. Via the exhaust manifold 9 and the exhaust pipe 5 the exhaust gases from the engine 1 are guided into the turbine 2a for rotating the turbocharger 2. An intake duct 6 and an intake manifold 8 connect the compressor 2b of the turbocharger 2 to the cylinders 11 of the engine 1. The compressor 2b pressurizes the intake air introduced into the engine 1. A charge air cooler 7 is arranged between the intake duct 6 and the intake manifold 8 for cooling the intake air. A by-pass channel 10 that is provided with a by-pass valve 12 connects the intake duct 6 to the exhaust pipe 5. Via the by-pass channel 10 excess intake air can be guided past the engine 1 directly into the exhaust pipe 5.

An electric motor 3 is connected with coupling means 4 to the shaft 2c of the turbocharger 2. In the embodiment of the FIGURE, the coupling means 4 is an adjustable magnetic coupler. The adjustable magnetic coupler 4 comprises a first rotor 4a and a second rotor 4b. The first rotor 4a is in connection with the shaft 3a of the electric motor 3 and rotates at the same speed as the electric motor 3. The second rotor 4b of the adjustable magnetic coupler 4 is in connection with the shaft 2c of the turbocharger 2 and rotates at the same speed as the turbocharger 2. There is no mechanical connection between the first rotor 4a and the second rotor 4b. The first rotor 4a of the adjustable magnetic coupler 4 is provided with a plurality of permanent magnets that are arranged on the circumference of the first rotor 4a. The second rotor 4b is provided with non-ferrous conductor elements. An adjustable gap 4c is arranged between the first rotor 4a and the second rotor 4b. This kind of adjustable magnetic couplers are known per se and commercially available.

There is a speed difference between the first rotor 4a and the second rotor 4b called slip. When the gap 4c between the first rotor 4a and the second rotor 4b is set at its minimum value, the slip between the rotors 4a, 4b is at its minimum value and almost all torque of the electric motor 3 is transmitted via the magnetic coupler 4 to the turbocharger 2. When the gap 4c is widened, the slip between the first rotor 4a and the second rotor 4b increases and less torque is transmitted to the turbocharger 2. When a certain gap 4c that is specific to the magnetic coupler 4c is reached, no torque is transmitted via the coupler 4 and the electric motor 3 and the turbocharger 2 are separated from each other.

The arrangement is provided with a control unit 13 for controlling the operation of the electric motor 3 and the adjustable magnetic coupler 4. Different sensors can be placed in different locations in the system for measuring operating conditions of the engine and the auxiliaries. In the FIGURE is shown a pressure sensor 14 for measuring the pressure of the intake air after the turbocharger 2.

Due to the adjustable magnetic coupler 4, the electric motor 3 can be operated at constant speed and the torque transmitted from the electric motor 3 to the turbocharger 2 can be steplessly adjusted by adjusting the gap 4c between the first rotor 4a and the second rotor 4b, without a need for a frequency controller. When the electric motor 3 is not needed for assisting the turbocharger 2, for instance at high or intermediate engine loads, the motor 3 can be completely detached from the turbocharger 2 and the turbocharger 2 can thus rotate freely. Because only the second rotor 4a of the adjustable magnetic coupler 4 is connected to the turbocharger 2, the rotating inertia of the turbocharger 2 is kept at minimum.

The turbocharging arrangement according to the present invention also enables the use of the electric motor 3 for braking the turbocharger 2. Because the adjustable magnetic coupler 4 can transmit torque in both directions, the turbocharger 2 can be used for rotating the electric motor 3 so that the motor 3 works as a generator and reduces the speed of the turbocharger 2. With this arrangement, it may even be possible to omit exhaust gas waste gates that are usually used for avoiding too high charge air pressures and excessive speed of the turbocharger 2 at high engine loads. The turbocharging arrangement is also provided with a battery 15, which can work as a power source for the electric motor 3 and store the energy produced by the motor 3 in the braking mode. Instead of the battery 15, a capacitor could be used to store the energy produced by the electric motor 3 in the braking mode.

At intermediate and high loads, if there is no need for braking the turbocharger 2, the electric motor 3 can be switched off and the adjustable magnetic coupler 4 disengaged to allow free operation of the turbocharger 2. The exhaust gases are thus not used for running the electric motor 2 and the energy of the exhaust gases can be utilized maximally. At low loads, the electric motor 3 can be switched on to keep the speed of the turbocharger 2 at a level that is required for maintaining a certain charge pressure. The charge pressure can be measured by the pressure sensor 14, and by adjusting the air gap 4c of the adjustable magnetic coupler 4, the speed of the turbocharger 2 can be maintained at an optimal level to have optimal charge air pressure at any engine load and speed. Differently from the typical turbocharging arrangements, where the charge air pressures at different load and speed points are defined by the power balance between the turbine side and the compressor side of the turbocharger 2, the charge pressures can be controlled independent of the power balance. This will enable optimal turbocharger performance at any operating point. Because of the adjustable magnetic coupler 4, the electric motor 3 can operate at constant speed.

The power supply of the electric motor 3 can be arranged in many different ways. For instance, in a marine installation the power needed for operating the electric motor 3 can be produced by the auxiliary engines of the vessel. Alternatively, the electricity can be produced by alternators directly driven by the main engine. The electricity could also be supplied from the battery 15. When the engine 1 is running at low loads, the battery 15 can be charged from the electric power supply system of the vessel. When the engine load is high and the electric motor 3 is acting as a generator to reduce the speed of the turbocharger 2, the battery 15 can be charged by the electric motor 3.

It will be appreciated by a person skilled in the art that the invention is not limited to the embodiments described above, but may vary within the scope of the appended claims.

1. A turbocharging arrangement for an internal combustion engine, the arrangement comprising:
a turbocharger comprising a turbine and a compressor being connected to a common shaft in a rotationally fixed manner,
an electric motor, and
coupling means for coupling the electric motor to the shaft of the turbocharger,
wherein the coupling means is arranged to steplessly adjust the torque transmitted between the electric motor and the turbocharger.

2. The arrangement according to claim 1 wherein the coupling means is an adjustable magnetic coupler.

3. The arrangement according to claim 2, wherein the adjustable magnetic coupler comprises a first rotor with a plurality of permanent magnets, the first rotor being separated by an adjustable air gap from a second rotor comprising non-ferrous conductor elements.

4. The arrangement according to claim 1, wherein the electric motor is a constant speed motor.

5. A method for operating a turbocharged internal combustion engine, the engine comprising
a turbocharger comprising a turbine and a compressor being connected to a common shaft in a rotationally fixed manner,
an electric motor, and
adjustable coupling means for coupling the electric motor to the shaft of the turbocharger,
wherein the torque transmitted by the coupling means between the electric motor and the turbocharger is adjusted according to the needed charge air pressure.

6. The method according to claim 5, wherein the torque transmitted is adjusted by an adjustable magnetic coupler.

7. The method according to claim 5, wherein the torque transmitted by the coupling means is adjusted according to the difference between the actual and desired charge air pressure.

8. The method according to claim 5, wherein the method comprises
a first mode, in which mode the turbocharger is operated on both the exhaust gases of the internal combustion engine and the electric motor,
a second mode, in which mode the turbocharger is operated on the exhaust gases of the internal combustion engine and the electric motor is disconnected from the turbocharger, and
a third mode in which mode the electric motor is used as a generator.

9. The method according to claim 5, wherein the electric motor is operated at constant speed.
